(19) United States
(12) Patent Application Publication
(10) Pub. No.: US 2023/0242203 A1
(43) Pub. Date: Aug. 3, 2023

(54) METER STAY, METER UNIT, AND BICYCLE

(71) Applicant: YAMAHA HATSUDOKI KABUSHIKI KAISHA, Iwata-shi (JP)

(72) Inventor: Toshihiro OTANI, Shizuoka (JP)

(21) Appl. No.: 18/104,360

(22) Filed: Feb. 1, 2023

(30) Foreign Application Priority Data
Feb. 2, 2022 (JP) 2022-014938

(51) Int. Cl. B62J 45/00; B62K 21/12

(52) U.S. Cl. CPC B62J 45/00; B62K 21/12; B62K 2204/00

(57) ABSTRACT

A meter stay to attach a meter to a vehicle includes a base to support the meter, an accommodation case to accommodate a portion of an electric cable to electrically connect the meter and an external device to each other, a bobbin around which a portion of the electric cable is windable and located inside the accommodation case, and an attachment tool to attach the base and the accommodation case to the vehicle. An axial direction of the bobbin has a polar angle larger than about 45 degrees and smaller than about 135 degrees with respect to a direction normal to a display plane of the meter supported by the base.

### CROSS REFERENCE TO RELATED APPLICATIONS

This application claims the benefit of priority to Japanese Patent Application No. 2022-014938 filed on Feb. 2, 2022. The entire contents of this application are hereby incorporated herein by reference.

### BACKGROUND OF THE INVENTION

### 1. Field of the Invention

The present invention relates to a meter stay, a meter unit, and a bicycle.

### 2. Description of the Related Art

Bicycles are widely used by a variety of people regardless of the age or gender as easy-to-use means of transportation. Recently, electrically assisted bicycles, by which power of users pedaling is assisted by electric motors, are increasingly widespread (see, for example, Japanese Laid-Open Patent Publication No. 2007-230411). Such an electrically assisted bicycle causes an electric motor to generate driving power corresponding to the power of a human body, specifically, the power provided by a user to a pedal, and thus alleviates the load imposed on the user while, for example, traveling on a slope or traveling with cargo.

An operation device including a plurality of switches accepting instructions from a rider is provided in the vicinity of a grip of a handle of the electrically assisted bicycle. The rider may operate one of the switches of the operation device to turn on or off the power of the electrically assisted bicycle or to set the magnitude of assist power to be generated by the electric motor.

A meter displaying various types of information regarding the electrically assisted bicycle is provided on the handle. A rider may look at the display of the meter to learn the state of the electrically assisted bicycle. The meter may be provided as a portion of the operation device or may be provided separately from the operation device.

In the case of being provided separately and far from each other, the meter and the operation device are electrically connected with each other via an electric cable. The meter and the operation device may be marketed as one unit. The electric cable is set to have a relatively long length so as to be usable for various models of electrically assisted bicycles. Therefore, the electric cable is slack for a model in which the distance between the meter and the operation device is short. The electric cable may be bundled with a brake wire to suppress, to some extent, significant sagging of the electric cable. However, there is a problem that the appearance of the electrically assisted bicycle is spoiled with such a slack electric cable.

### SUMMARY OF THE INVENTION

Preferred embodiments of the present invention provide meter stays that each accommodate an extra portion of an electric cable such that the extra portion is inconspicuous.

A meter stay to be attached to a meter of a vehicle according to a preferred embodiment of the present invention includes a base to support the meter, an accommodation case to accommodate a portion of an electric cable to electrically connect the meter and an external device to each other, a bobbin around which a portion of the electric cable is windable and located inside the accommodation case, and an attachment tool to attach the base and the accommodation case to the vehicle. An axial direction of the bobbin has a polar angle larger than about 45 degrees and smaller than about 135 degrees with respect to a direction normal to a display plane of the meter supported by the base.

In order to reduce the load imposed on the electric cable caused by bending the electric cable, the electric cable is wound around the bobbin while being slightly bent. This increases the size, in a diametric direction, of the bobbin around which the electric cable is wound, and also increases the size of the accommodation case in the diametric direction of the bobbin. If the axial direction of the bobbin is close to the direction normal to the display plane of the meter, a large surface of the accommodation case extending in the diametric direction of the bobbin is conspicuous to a rider of the vehicle. This spoils the appearance of the vehicle.

According to a preferred embodiment of the present invention, the axial direction of the bobbin has a polar angle larger than about 45 degrees and smaller than about 135 degrees with respect to the direction normal to the display plane of the meter. With this arrangement, the large surface of the accommodation case extending in the diametric direction of the bobbin is made inconspicuous to the rider, and the appearance of the vehicle is improved.

Even in the case where there is no component such as a brake wire or the like that is to be bundled with the electric cable, an extra portion of the electric cable may be accommodated in the accommodation case to alleviate the slack state of the electric cable.

In a preferred embodiment of the present invention, the accommodation case may include a first housing and a second housing defining a space therebetween to accommodate the bobbin and the portion of the electric cable. The first housing and the second housing may be secured to each other by a fastener. The fastener may pass inside the bobbin.

The structure in which the fastener passes inside the bobbin allows an inner space of the bobbin to be used effectively. A portion of the accommodation case that is outward of the bobbin does not need to have a space in which the fastener passes. This decreases the size of the meter stay.

In a preferred embodiment of the present invention, the accommodation case may include a first housing and a second housing defining a space therebetween to accommodate the bobbin and the portion of the electric cable, and a boss to position the first housing and the second housing with respect to each other. The first housing and the second housing may be secured to each other by a fastener. A distance between the boss and the fastener may be longer than a distance between the boss and a central axis of the bobbin in a planar view as seen in the axial direction of the bobbin.

With this structure, the position at which the first housing and the second housing are secured to each other by the fastener is far from the boss. This reduces or prevents a deviation of the relative positions of the first housing and the second housing.

In a preferred embodiment of the present invention, the accommodation case may include a first housing and a second housing defining a space therebetween to accommodate the bobbin and the portion of the electric cable, and a boss to position the first housing and the second housing with respect to each other. A distance between an outer circumference of the bobbin and an outer circumference of the boss may be longer than a diameter of the electric cable and shorter than about twice the diameter of the electric cable.

With this structure, the space accommodating the electric cable is provided with certainty while the size of the accommodation case in the diametric direction of the bobbin is decreased. This structure also causes the electric cable wound around the bobbin to contact the boss. This reduces or prevents a deviation of the position of the electric cable.

In a preferred embodiment of the present invention, the accommodation case may include a first housing and a second housing defining a space therebetween to accommodate the bobbin and the portion of the electric cable. The bobbin and one of the first housing and the second housing are integral and unitary with each other.

This structure allows an inner wall of the housing to act as a flange of the bobbin. The integral manufacture of the housing and the bobbin decreases the number of components. In the case where the housing and the bobbin are integral and unitary with each other and made of a resin, the manufacture thereof is made easy.

In a preferred embodiment of the present invention, the accommodation case may include a first housing and a second housing defining a space therebetween to accommodate the bobbin and the portion of the electric cable. The first housing may be connected with the base and the attachment tool. The first housing may be made of a metal material. The second housing may be made of a resin material.

Manufacture of the first housing of a metal material provides the meter stay with a required level of strength. Manufacture of the second housing of a resin makes the meter stay lightweight. In the case where the electric cable has a large load imposed thereon, the second housing made of a resin may be broken and thus reduces or prevents destruction of the rest of the meter stay and the meter.

In a preferred embodiment of the present invention, the accommodation case may include an opening through which the electric cable passes. The opening may be open in a diametric direction of the bobbin.

If the opening opens in the axial direction of the bobbin, the accommodation case needs to have a space that allows the electric cable to pass through the opening while the electric cable is slightly bent. This increases the size of the accommodation case in the axial direction of the bobbin. The structure in which the opening is opened in the diametric direction of the bobbin decreases the size of the accommodation case in the axial direction of the bobbin.

In a preferred embodiment of the present invention, the accommodation case may include a plurality of openings through which the electric cable passes.

With this structure, a portion of the electric cable that extends from the accommodation case toward the meter and a portion of the electric cable that extends from the accommodation case toward an external device are allowed to pass through the different openings. This structure does not require the accommodation case to have a space that guides the two portions of the electric cable to one opening, and therefore, decreases the size of the accommodation case.

In a preferred embodiment of the present invention, a size of the accommodation case as seen in the axial direction of the bobbin may be larger than a size of the meter as seen in the direction normal to the display plane of the meter.

Even in the case where the size of the accommodation case is larger than the size of the meter, the accommodation case is made inconspicuous to the rider.

A meter unit according to a preferred embodiment of the present invention includes the meter stay described above and a meter to display information, wherein the meter is supported by the base.

The meter unit has a good appearance with the accommodation case being inconspicuous to the rider.

A bicycle according to a preferred embodiment of the present invention includes the meter unit described above.

The bicycle has a good appearance with the accommodation case being inconspicuous to the rider.

In a preferred embodiment of the present invention, the meter and the accommodation case may not overlap each other as seen in a top view of the bicycle.

If the accommodation case protrudes from the meter as seen from the rider, the meter may appear to have a large size to the rider. In a preferred embodiment of the present invention, the meter and the accommodation case do not overlap each other as seen from the rider. Therefore, the meter looks neat, and the appearance of the electrically assisted bicycle is improved.

In a preferred embodiment of the present invention, the meter stay may be attached to a handle bar, a handle stem, or a handle column. A front end of the accommodation case may be located rearward of a front end of the handle bar, the handle stem, or the handle column.

With this structure, the accommodation case does not protrude outward from the electrically assisted bicycle. This structure reduces or prevents contact of the accommodation case with an object located in the vicinity of the electrically assisted bicycle. The structure in which the accommodation case does not protrude outward from the electrically assisted bicycle improves the appearance of the electrically assisted bicycle.

In a preferred embodiment of the present invention, the axial direction of the bobbin may have a polar angle larger than about 45 degrees and smaller than about 135 degrees with respect to an up-down direction of the bicycle.

Even in the case where the size of the accommodation case in the diametric direction of the bobbin is large, the bicycle has a good appearance with the accommodation case being inconspicuous to the rider.

In a preferred embodiment of the present invention, the meter stay may be attached to a handle bar, a handle stem, or a handle column. The accommodation case may include a first housing and a second housing defining a space therebetween to accommodate the bobbin and the portion of the electric cable, and a boss to position the first housing and the second housing with respect to each other. The boss may be located rearward of a central portion of the accommodation case in a front-rear direction of the bicycle.

At a position closer to the boss, the first housing and the second housing may be positionally deviated less from each other. In a preferred embodiment of the present invention, the boss is located at a position in the accommodation case that is close to a portion viewable by the rider. This improves the appearance of the electrically assisted bicycle.

In a preferred embodiment of the present invention, the accommodation case may include an opening through which the electric cable passes. The opening may be located below a central portion of the accommodation case in an up-down direction of the bicycle.

With this structure, the electric cable extends from a position in the accommodation case that is not easily viewed from the rider. This improves the appearance of the electrically assisted bicycle. In addition, this structure reduces or prevents entry of water into the accommodation case through the opening.

A meter stay according to a preferred embodiment of the present invention includes an accommodation case accommodating a portion of an electric cable electrically connecting a meter and an external device to each other. A bobbin around which the electric cable is wound is accommodated in the accommodation case.

In order to reduce the load imposed on the electric cable caused by bending the electric cable, the electric cable is wound around the bobbin while being slightly bent. This increases the size of the bobbin in a diametric direction thereof, and also increases the size of the accommodation case in the diametric direction of the bobbin. If the axial direction of the bobbin is close to a direction normal to a display plane of the meter, a large surface of the accommodation case extending in the diametric direction of the bobbin is conspicuous to the rider of the vehicle. This spoils the appearance of the vehicle.

According to a preferred embodiment of the present invention, the axial direction of the bobbin has a polar angle larger than about 45 degrees and smaller than about 135 degrees with respect to the direction normal to the display plane of the meter. With this arrangement, the large surface of the accommodation case extending in the diametric direction of the bobbin is made inconspicuous to the rider, and the appearance of the vehicle is improved.

According to a preferred embodiment of the present invention, even in the case where there is no component such as a brake wire or the like that is to be bundled with the electric cable, an extra portion of the electric cable may be accommodated in the accommodation case to alleviate a slack state of the electric cable.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a side view showing an electrically assisted bicycle 1 according to a preferred embodiment of the present invention.

FIG. 2 is a top view showing a front portion of the electrically assisted bicycle 1 according to a preferred embodiment of the present invention.

FIG. 3 is a top view of a meter unit 5 according to a preferred embodiment of the present invention.

FIG. 4 is a top view showing a meter stay 50 and a meter 70 according to a preferred embodiment of the present invention.

FIG. 5 shows a hardware configuration of the meter 70 according to a preferred embodiment of the present invention.

FIG. 6 is a perspective view of the meter unit 5 according to a preferred embodiment of the present invention.

FIG. 7 is a perspective view showing a first housing 61 and a second housing 62 according to a preferred embodiment of the present invention.

FIG. 8 is a side view showing the second housing 62 according to a preferred embodiment of the present invention.

FIG. 9 is a side view showing an accommodation case 60, in which an electric cable 105 is wound around a bobbin 63, according to a preferred embodiment of the present invention.

FIG. 10 shows a relationship between an axial direction AD1 of the bobbin 63 and a normal direction ND1 to a display plane 72 of the meter 70 according to a preferred embodiment of the present invention.

FIG. 11 shows an example of the size relationship between the accommodation case 60 and the meter 70 according to a preferred embodiment of the present invention.

FIG. 12 is a top view showing the meter unit 5 attached to a handle bar 41 according to a preferred embodiment of the present invention.

### DETAILED DESCRIPTION OF THE PREFERRED EMBODIMENTS

Hereinafter, meter stays, meter units, and bicycles according to preferred embodiments of the present invention will be described with reference to the attached drawings. In the description of the preferred embodiments, like elements will bear like reference signs, and overlapping descriptions will be omitted. The following preferred embodiments are merely examples, and do not limit the present invention in any way.

A meter unit according to a preferred embodiment of the present invention is mounted on a vehicle. The vehicle is, for example, an electrically assisted bicycle. The vehicle is not limited to an electrically assisted bicycle, and may be a bicycle that does not have a function of assisting, by an electric motor, the power of a user pedaling. The vehicle on which the meter unit is mounted is not limited to a bicycle and may be, for example, a two-wheel vehicle driven by an electric motor or an internal combustion engine, or a vehicle including three or more wheels. In the following preferred embodiments, electric assisted bicycles will be described as examples of the vehicle.

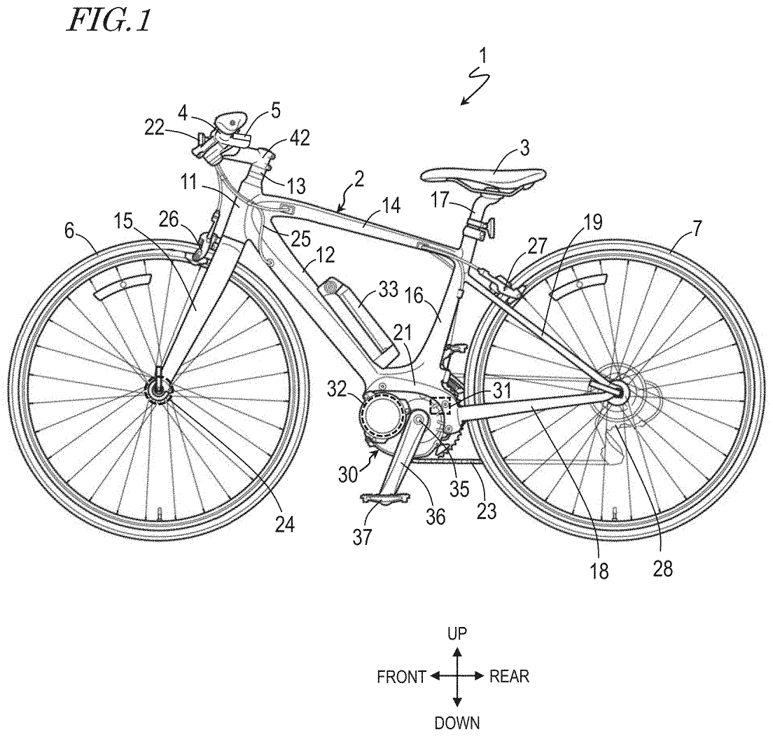

FIG. 1 is a side view of an electrically assisted bicycle 1 according to a preferred embodiment of the present invention. Regarding the electrically assisted bicycle 1 shown in FIG. 1, “front”, “rear”, “up”, “down”, “left”, and “right” respectively refer to front, rear, up, down, left, and right for a rider sitting on a saddle 3 of the electrically assisted bicycle 1 while facing a handle 4.

The electrically assisted bicycle 1 includes a body frame 2 extending in a front-rear direction. The body frame 2 includes a head pipe 11, a down tube 12, a top tube 14, a seat tube 16, a chain stay 18, a seat stay 19, and a bracket 21. The head pipe 11 is located at a front end of the body frame 2. A handle column 13 is rotatably inserted into the head pipe 11. A hand stem 42 is secured to a top portion of the handle column 13, and the handle 4 is secured to a front portion of the handle stem 42. A meter unit 5 to display various types of information on the electrically assisted bicycle 1 is provided on the handle 4. A head lamp 22 is provided to the front of the handle 4.

A front fork 15 is secured to a bottom end of the handle column 13. A bottom end of the front fork 15 supports a front wheel 6, which is a steering wheel, such that the front wheel 6 is rotatable. A speed sensor 24 to detect the rotation of the front wheel 6 is provided at the bottom end of the front fork 15. A brake 26 to brake the front wheel 6 is provided on the front fork 15.

The down tube 12 extends obliquely rearward and downward from the head pipe 11. The seat tube 16 extends upward from a rear end of the down tube 12. The chain stay 18 extends rearward from a bottom end of the seat tube 16. The bracket 21 connects the rear end of the down tube 12, the bottom end of the seat tube 16, and a front end of the chain stay 18 to each other. The top tube 14 connects the head pipe 11 and a top portion of the seat tube 16 to each other. A seat post 17 is inserted into the seat tube 16. The saddle 3, on which the rider sits, is provided at a top end of the seat post 17.

A rear end of the chain stay 18 supports a rear wheel 7, which is a driving wheel, such that the rear wheel 7 is rotatable. The seat stay 19 extends obliquely rearward and downward from the top portion of the seat tube 16. A bottom end of the seat stay 19 is connected with the rear end of the chain stay 18. A brake 27 to brake the rear wheel 7 is provided on the seat stay 19. A transmission 28 to change the transmission ratio is provided at the rear end of the chain stay 18. The transmission 28 may be provided in the vicinity of a crank shaft 35.

The bracket 21 of the body frame 2 is located near a center of the vehicle, and a driving unit 30 is provided on the bracket 21. The driving unit 30 includes an electric motor 32, the crank shaft 35, and an MCU (motor control unit) 31. A battery 33 to supply power to the driving unit 30 and the like is mounted on the down tube 12. The battery 33 may be mounted on the bracket 21 or the seat tube 16. The battery 33 may be detachable from the electrically assisted bicycle 1. The battery 33 may be provided inside the body frame 2, for example, inside the down tube 12.

The crank shaft 35 is supported by the driving unit 30 while extending through the driving unit 30 in a left-right direction. Crank arms 36 are provided at both of two ends of the crank shaft 35. Pedals 37 are rotatably provided at tips of the crank arms 36.

The MCU 31 controls an operation of the electric motor 32, and also controls operations of various components of the electrically assisted bicycle 1. The MCU 31 includes, for example, a semiconductor integrated circuit such as a processor or the like and a motor driving circuit. A rotation of the crank shaft 35 generated by the rider stepping on the pedals 37 is conveyed to the rear wheel 7 via a chain 23. The MCU 31 controls the electric motor 32 to generate a driving assisting output corresponding to the rotation output of the crank shaft 35 generated by the rider stepping on the pedals 37. Assist power generated by the electric motor 32 is conveyed to the rear wheel 7 via the chain 23. Instead of the chain, a belt, a shaft or the like may be used.

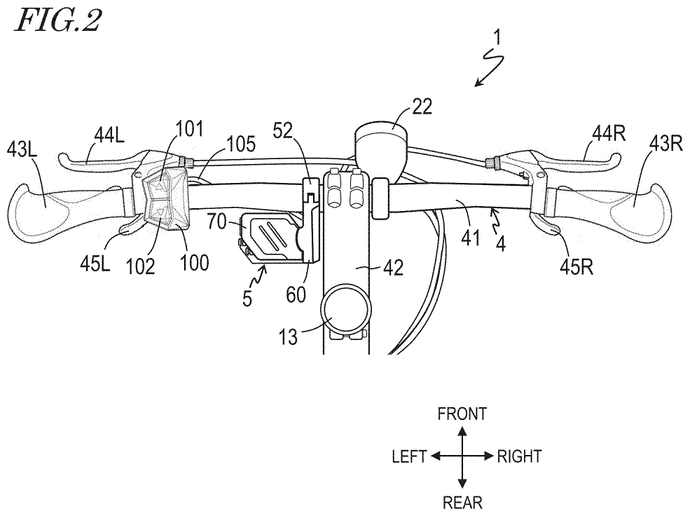

FIG. 2 is a top view showing a front portion of the electrically assisted bicycle 1. The handle 4 includes a handle bar 41. A right grip 43R is provided at a right end of the handle bar 41. A left grip 43L is provided at a left end of the handle bar 41. The rider grips the right grip 43R and the left grip 43L with his/her hands to steer the bicycle.

A front wheel brake lever 44R and a shift controller 45R are provided in the vicinity of the right grip 43R. A rear wheel brake lever 44L and a shift controller 45L are provided in the vicinity of the left grip 43L. When the right grip 43R and the front wheel brake lever 44R are gripped by the right hand of the rider, braking power is provided to the front wheel 6. When the left grip 43L and the rear wheel brake lever 44L are gripped by the left hand of the rider, braking power is provided to the rear wheel 7. The brake lever provided to the left of the handle bar 41 may be the front wheel brake lever providing the front wheel 6 with the braking power, and the brake lever provided to the right of the handle bar 41 may be the rear wheel brake lever providing the rear wheel 7 with the braking power. The shift controllers 45R and 45L are also referred as “shifters”. The rider may switch the transmission ratio by operating the shift controllers 45R and 45L.

The meter unit 5 is provided on the handle bar 41. The meter unit 5 includes a meter 70 to display information on the electrically assisted bicycle 1. In this example, the meter unit 5 is attached to a position of the handle bar 41 that is near the handle stem 42 via an attachment tool 52 such as a clamp or the like.

An operation device 100 is provided in the vicinity of the left grip 43L of the handle 4. The operation device 100 is attached to the handle 4 via an attachment tool such as a clamp or the like. The rider may, for example, set the magnitude of the assist power of the electric motor 32 by operating the operation device 100 with his/her finger. The meter 70 and the operation device 100 are electrically connected with each other via an electric cable 105. A signal corresponding to an operation of the rider is sent from the operation device 100 to the meter 70 via the electric cable 105. The meter 70 and the MCU 31 of the driving unit 30 (see FIG. 1) may send and receive signals to each other via an electric cable 25 (see FIG. 1).

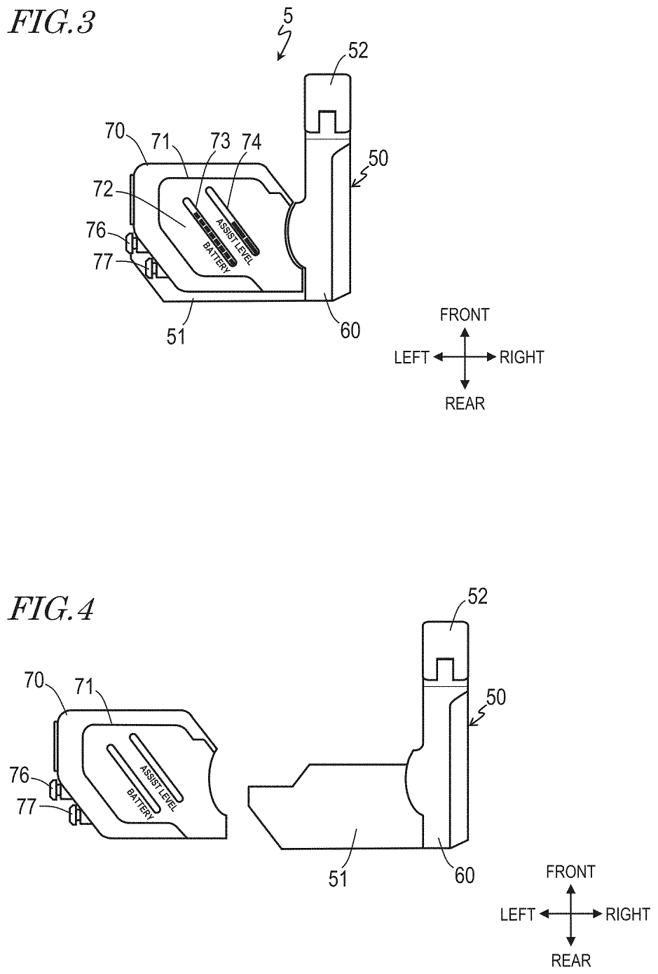

Now, the meter unit 5 will be described in detail. FIG. 3 is a top view of the meter unit 5. The meter unit 5 includes the meter 70 and a meter stay 50 to attach the meter 70 to the electrically assisted bicycle 1. FIG. 4 is a top view of the meter stay 50 and the meter 70 in a separated state.

The meter stay 50 includes a base 51 to support the meter 70, an accommodation case 60 to accommodate a portion of the electric cable 105, and an attachment tool 52 to attach the base 51 and the accommodation case 60 to the electrically assisted bicycle 1. The attachment tool 52 is, for example, a clamp, but is not limited thereto. The meter unit 5 is attached to, for example, the handle bar 41 of the electrically assisted bicycle 1 via the attachment tool 52.

The meter 70 may be attached to the base 51 by, for example, being fitted thereto. The meter 70 may be attached to the base 51 by use of, for example, snap-fit. The meter 70 may be attached to the base 51 by a fastening member such as a bolt or the like or with an adhesive. The meter 70 may be detachable from the meter stay 50.

The meter 70 includes a display device 71 to display information on the electrically assisted bicycle 1 and a plurality of switches 76 and 77 to accept operations of the rider. The plurality of switches are, specifically, a power switch 76 and a lamp activation switch 77. In this preferred embodiment, these switches are push-button switches, which are pushed down by the rider to be turned on or off.

The power switch 76 turns on or off the power of the electrically assisted bicycle 1. When the power of the electrically assisted bicycle 1 is on, the driving unit 30 operates, whereas when the power of the electrically assisted bicycle 1 is off, the driving unit 30 does not operate. When the rider pushes down the power switch 76 while the power is off, the power is turned on. When the rider pushes down the power switch 76 while the power is on, the power is turned off.

The lamp activation switch 77 turns the head lamp 22 (FIG. 1) on or off. When the rider pushes down the lamp activation switch 77 while the head lamp 22 is off, the head lamp 22 is turned on and emits light to illuminate the road ahead of the electrically assisted bicycle 1. When the rider pushes down the lamp activation switch 77 while the head lamp 22 is on, the head lamp 22 is turned off.

The display device 71 includes a display plane 72 to display information on the electrically assisted bicycle 1. The display plane 72 is generally directed upward, so that the rider may visually recognize the displayed contents easily. In this preferred embodiment, for an easy-to-understand description of the features of the meter unit 5, the display plane 72 is assumed to be flat. In the example shown in FIG. 3, the display device 71 displays battery remaining charge information 73 indicating the remaining charge of the battery 33, and assist mode information 74 indicating the assist mode selected by the rider.

The operation device 100 (FIG. 2) includes assistance power setting switches 101 and 102. The assistance power setting switches 101 and 102 set the assist power of the electric motor 32. In this preferred embodiment, the electrically assisted bicycle 1 allows one of a plurality of assist modes to be selected. The plurality of assist modes include, for example, an assist-free mode, an ecological mode, a smart mode, and a high mode, in the order from the mode in which the magnitude of the assist power assisting the power of a human body is lowest. In the assist-free mode, the electric motor 32 does not generate any assist power. Each time the rider pushes down the assistance power setting switch 101, the assist mode is switched from the mode in which the assist power assisting the power of the human body is relatively lower to the mode in which the assist power is relatively higher. Each time the rider pushes down the assistance power setting switch 102, the assist mode is switched from the mode in which the assist power assisting the power of the human body is relatively higher to the mode in which assist power is relatively lower.

In the above-described example, there are four types of assist modes. The number of the types of assist modes may be three or less, or five or more. For example, there may be a mode to provide assist power higher than that of the high mode, or there may be a plurality of types of ecological modes.

In a preferred embodiment of the present invention, the display device 71 displays an indicator that indicates the remaining charge of the battery 33 as the battery remaining charge information 73. In the example shown in FIG. 3, the indicator 73 includes a plurality of segments, and the number of the segments displayed as being “on” changes in accordance with the battery remaining charge. The rider may intuitively perceive the remaining charge of the battery 33 by looking at the indicator 73.

The display device 71 displays an indicator that displays the assist mode selected by the rider as the assist mode information 74. The indicator 74 includes a plurality of segments, and the number of the segments displayed as being “on” changes in accordance with the selected assist mode. The rider may intuitively perceive the assist level corresponding to the selected assist mode by looking at the indicator 74.

In the case of displaying a segment-system indicator, the display device 71 may include an array of a plurality of lamps such as LEDs (Light Emitting Diodes) or the like to realize an indicator. Alternatively, the display device 71 may include a display panel such as a liquid crystal panel or the like and cause the display panel to display various types of information on the electrically assisted bicycle 1 such as, for example, the battery remaining charge information 73 and the assist mode information 74. The display panel may display the information by the segment system or the dot matrix system. The display panel may be a panel other than the liquid crystal panel, for example, an OLED (Organic Light-Emitting Diode) panel or an electronic paper panel.

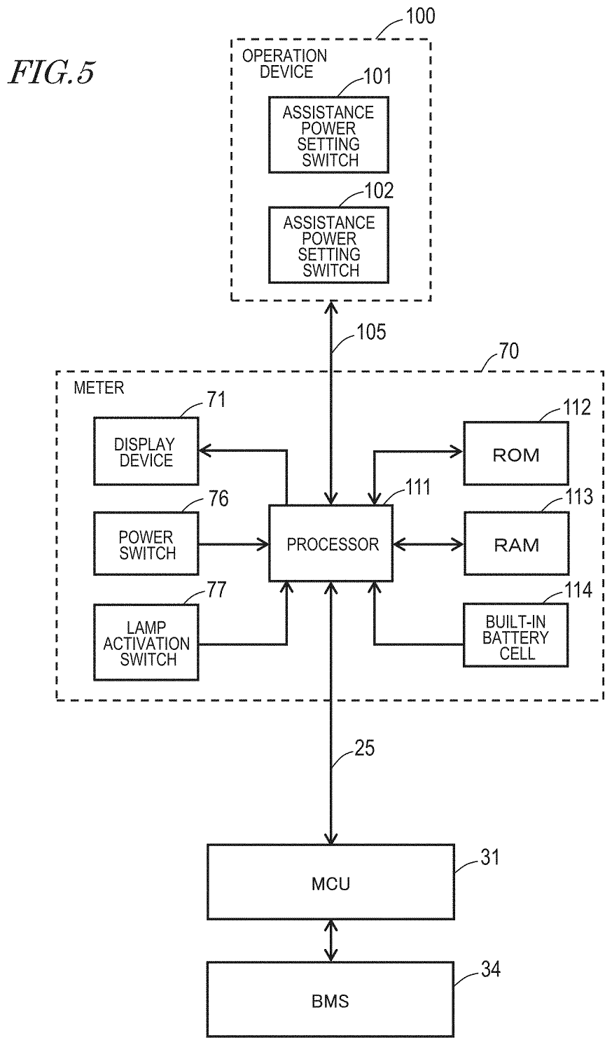

FIG. 5 shows a hardware configuration of the meter 70. The meter 70 further includes a processor 111, storage mediums such as a ROM (Read Only Memory) 112, a RAM (Random Access Memory) 113 and the like, and a built-in battery cell 114.

The processor 111 may be, for example, a semiconductor integrated circuit. The processor 111 may operate by use of electric power supplied from the built-in battery cell 114. In a state where the electrically assisted bicycle 1 is on, the processor 111 may operate by use of the electric power supplied from the battery 33. The built-in battery cell 114 includes, for example, a primary battery such as a coin battery or the like. The built-in battery cell 114 may be a rechargeable secondary battery.

The ROM 112 stores a computer program (or firmware) causing the processor 111 to execute a process. The processor 111 reads the computer program stored on the ROM 112 and executes the computer program stored in the RAM 113 to perform various processes. The ROM 112 and the RAM 113 may be incorporated into the processor 111.

The processor 111 detects that any one of the various switches has been pushed down, or controls the operation of the display device 71. For example, when the rider starts pushing down a switch, the processor 111 detects a voltage value and/or a current value of a predetermined level or higher. When the rider stops pushing down the switch, the processor 111 detects that the voltage value and/or the current value detected so far has become, for example, zero. The processor 111 may detect, in parallel, a plurality of switches being pushed down at the same time.

In accordance with the switch of the meter 70 or the operation device 100 that has been pushed down, the processor 111 controls the display device 71 to change the contents to be displayed. The processor 111 sends a signal corresponding to the pushing operation on any of the switches to the MCU 31. For example, the processor 111 may send a signal indicating the selected assist mode to the MCU 31. The MCU 31, upon receiving the signal, controls the electric motor 32 to generate the assist power corresponding to the selected assist mode.

A BMS (Battery Management System) 34 is mounted on the battery 33. The BMS 34 controls various operations of, for example, charging or discharging the battery 33, and monitors the various states of the battery 33. The BMS 34 monitors the voltage, current, temperature, SOC (State of Charge) and the like of the battery 33. The MCU 31 and the BMS 34 send and receive necessary information to each other. The MCU 31 receives battery information indicating the voltage, current, temperature, SOC and the like of the battery 33 from the BMS 34.

The MCU 31 outputs SOC information indicating the SOC of the battery 33 to the meter 70. The processor 111 controls the display device 71 to display the information on the battery remaining charge corresponding to the battery remaining charge calculated based on the SOC information.

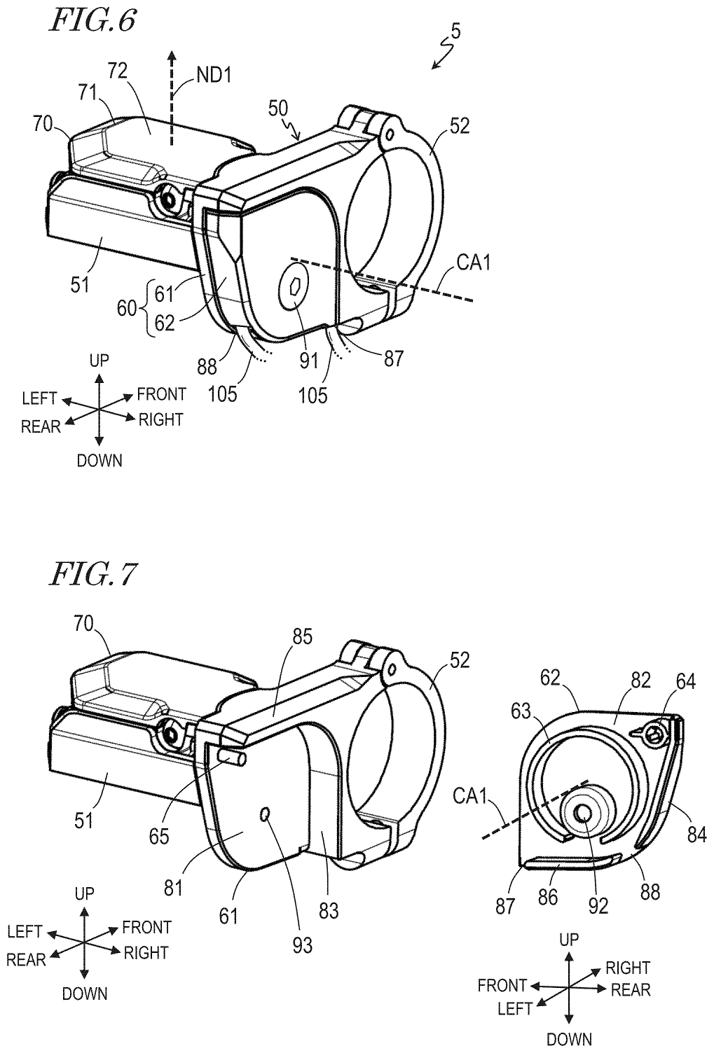

Now, the accommodation case 60 of the meter unit 5 will be described in detail. FIG. 6 is a perspective view of the meter unit 5. The accommodation case 60 accommodates a portion of the electric cable 105 electrically connecting the meter 70 and the operation device 100 to each other.

The meter 70 and the operation device 100 may be marketed as one unit. The electric cable 105 is set to have a relatively long length so as to be usable for various models of electrically assisted bicycles 1. Therefore, the electric cable 60 may be slack for a model by which the distance between the meter 70 and the operation device 100 is short. The accommodation case 60 in this preferred embodiment accommodates such an extra portion of the electric cable 105 to alleviate the slack state of the electric cable 105.

The accommodation case 60 includes a first housing 61 and a second housing 62, which define a space therebetween to accommodate a portion of the electric cable 105, by being assembled together. The first housing 61 and the second housing 62 are secured to each other by a fastening member 91 such as a bolt or the like. The accommodation case 60 includes, in a bottom portion thereof, openings 87 and 88, through which the electric cable 105 passes. The first housing 61 also acts as a frame of the meter stay 50. The first housing 61 is connected with the base 51 and the attachment tool 52.

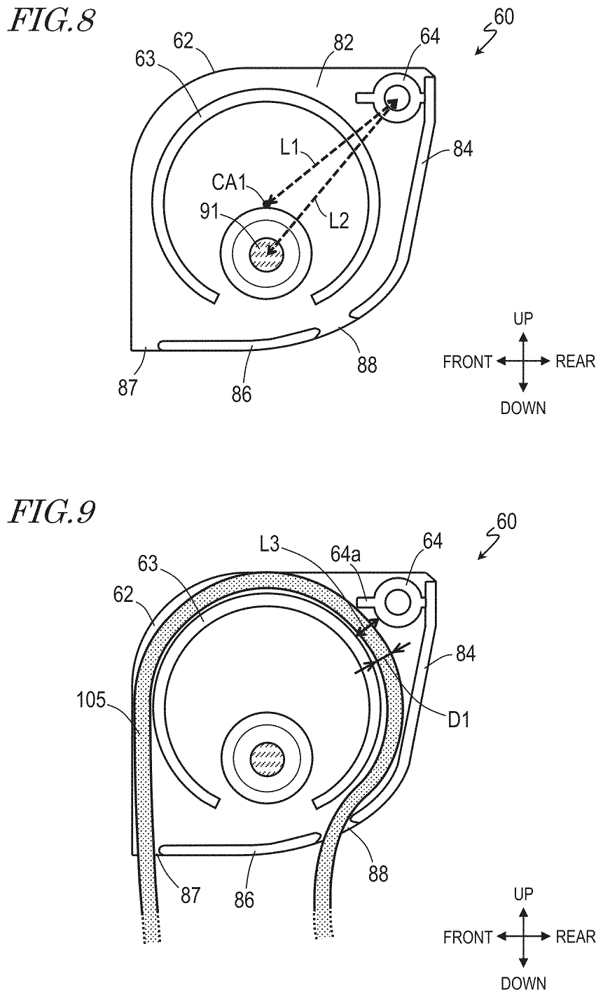

FIG. 7 is a perspective view showing the first housing 61 and the second housing 62 in a separated state. FIG. 8 is a left side view showing the second housing 62.

The first housing 61 includes a left wall portion 81 expanding mainly in the front-rear direction and in an up-down direction, a front wall portion 83 expanding mainly in the left-right direction and in the up-down direction, and a top wall portion 85 expanding mainly in the front-rear direction and in the left-right direction. The second housing 62 includes a right wall portion 82 expanding mainly in the front-rear direction and in the up-down direction, a rear wall portion 84 expanding mainly in the left-right direction and in the up-down direction, and a bottom wall portion 86 expanding mainly in the front-rear direction and in the left-right direction. The first housing 61 and the second housing 62 are assembled together to define a space therein.

The second housing 62 includes a hole 92 through which the fastening member 91 passes. The first housing 61 includes a hole 93 to which the fastening member 91 is secured. For example, the fastening member 91 has a male thread, a wall surrounding the hole 93 has a female thread, and the fastening member 91 and the wall surrounding the hole 93 are geared with each other to secure the first housing 61 and the second housing 62 to each other.

The second housing 62 includes a boss 64 to position the first housing 61 and the second housing 62 with respect to each other. The first housing 61 includes a pin 65 to position the first housing 61 and the second housing 62 with respect to each other. The pin 65 is inserted into the boss 64 to position the first housing 61 and the second housing 62 with respect to each other with high precision.

In the space defined by the first housing 61 and the second housing 62, a bobbin 63, around which the electric cable 105 is to be wound, is located. In the example shown in FIG. 7, the bobbin 63 is integral and unitary with the second housing 62. The bobbin 63 may be separate from the second housing 62. In the example shown in FIG. 7, the bobbin 63 has a cylindrical shape that is partially cut off.

FIG. 9 is a left side view showing the accommodating case 60 in a state where the electric cable 105 is wound around the bobbin 63. In order to show an internal structure of the accommodation case 60 in an easy-to-understand manner, FIG. 9 does not show the first housing 61. A portion of the electric cable 105 is wound around the bobbin 63 in a state where the first housing 61 and the second housing 62 are separate from each other, and then the first housing 61 and the second housing 62 are assembled together. In this manner, the extra portion of the electric cable 105 is accommodated in the accommodation case 60.

Now, the direction of a central axis CA1 (FIG. 6 and FIG. 7) of the cylindrical bobbin 63 will be described. In the meter unit 5 in this preferred embodiment, when the display plane 72 of the meter 70 is directed generally upward, the central axis CA1 of the cylindrical bobbin 63 (FIG. 6 and FIG. 7) may be directed generally horizontally.

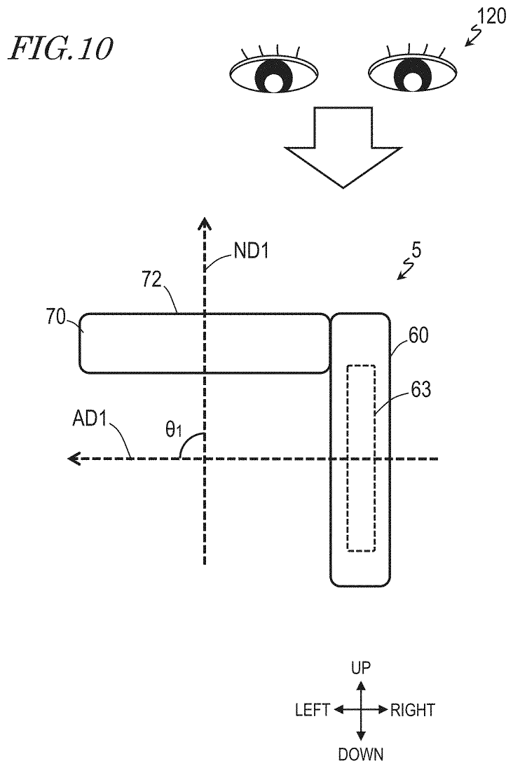

FIG. 10 shows the relationship between an axial direction AD1 of the bobbin 63 and a direction normal to the display plane 72 of the meter 70 (referred to as “the normal direction ND1 to the display plane 72”). The axial direction AD1 of the bobbin 63 is the direction of the central axis CA1 of the cylindrical bobbin 63. The axial direction AD1 may be generally vertical to a direction in which the electric cable 105 is wound around the bobbin 63.

In this preferred embodiment, the axial direction AD1 of the bobbin 63 has a polar angle θ₁ larger than about 45 degrees and smaller than about 135 degrees with respect to the normal direction ND1 to the display plane 72. The “polar angle θ₁” is a counterclockwise angle with the normal direction ND1 being set as 0 degrees.

When being put into the accommodation case 60, the electric cable 105 is bent. This imposes a load on the electric cable 105. In order to reduce the load, the electric cable 105 is wound around the bobbin 63 while being slightly bent. This increases the size of the bobbin 63 in a diametric direction thereof, and also increases the size of the accommodation case 60 in the diametric direction of the bobbin 63. If the axial direction AD1 of the bobbin 63 is close to the normal direction ND1 to the display plane 72 of the meter 70, a large surface of the accommodation case 60 extending in the diametric direction of the bobbin 63 is conspicuous to the rider of the electrically assisted bicycle 1. This spoils the appearance of the electrically assisted bicycle 1.

In this preferred embodiment, the axial direction AD1 of the bobbin 63 has the polar angle θ₁ larger than about 45 degrees and smaller than about 135 degrees with respect to the normal direction ND1 to the display plane 72 of the meter 70. With this arrangement, as seen in a front view of the meter unit 5, the axial direction AD1 of the bobbin 63 is closer to a direction vertical to the normal direction ND1 to the display plane 72 than to the normal direction ND1. In the case where, for example, the normal direction ND1 is the up-down direction, the axial direction AD1 of the bobbin 63 is closer to the horizontal direction than to the up-down direction. Therefore, the large surface of the accommodation case 60 extending in the diametric direction of the bobbin 63 is made inconspicuous to the rider (represented by reference numeral 120 in FIG. 10). This improves the appearance of the electrically assisted bicycle 1.

In a preferred embodiment of the present invention, even in the case where there is no component such as a brake wire or the like that is to be bundled with the electric cable 105, the extra portion of the electric cable 105 may be accommodated in the accommodation case 60 to alleviate the slack state of the electric cable 105.

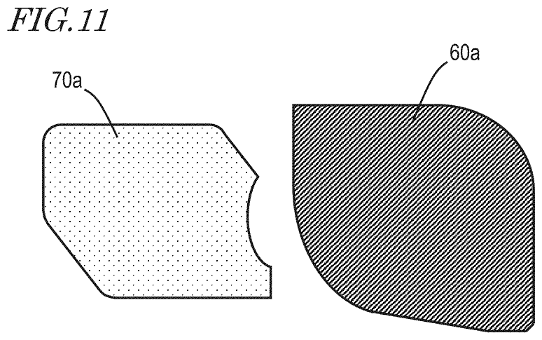

As described above, the size of the accommodation case 60 as seen in the axial direction AD1 of the bobbin 63 may be large. In the case where the meter 70 is of a small size, the size of the accommodation case 60 as seen in the axial direction AD1 of the bobbin 63 may be larger than the size of the meter 70 as seen in the normal direction ND1 to the display plane 72 of the meter 70. FIG. 11 shows an example of the size relationship between the accommodation case 60 and the meter 70. FIG. 11 shows a projection 60a of the accommodation case 60 projected onto a plane vertical to the axial direction AD1 and a projection 70a of the meter 70 projected onto a plane vertical to the normal direction ND1. In this preferred embodiment, even in the case where the size of the accommodation case 60 is larger than the size of the meter 70 as in this case, the accommodation case 60 is made inconspicuous to the rider.

In the case where the display plane 72 of the meter 70 includes a curved plane, the normal direction ND1 may be, for example, a direction normal to a central portion of the display plane 72, or may be an average of directions normal to a plurality of positions of the display plane 72.

The polar angle θ₁ of the axial direction AD1 of the bobbin 63 with respect to the normal direction ND1 to the display plane 72 may be about 60 degrees or larger and about 120 degrees or smaller. Even in this case, the large surface of the accommodation case 60 is made inconspicuous to the rider, and therefore, the appearance of the electrically assisted bicycle 1 is improved.

In a state where the meter unit 5 is mounted on the electrically assisted bicycle 1, the polar angle of the axial direction AD1 of the bobbin 63 with respect to the up-down direction of the electrically assisted bicycle 1 may be larger than about 45 degrees and smaller than about 135 degrees. The polar angle of the axial direction AD1 of the bobbin 63 with respect to the up-down direction of the electrically assisted bicycle 1 may be about 60 degrees or larger and about 120 degrees or smaller. With such a setting, the electrically assisted bicycle 1 has a good appearance with the accommodation case 60 being inconspicuous to the rider.

As described above with reference to FIG. 6 through FIG. 9, the first housing 61 and the second housing 62 of the accommodation case 60 are secured to each other by the fastening member 91. In this preferred embodiment, the hole 92, through which the fastening member 91 passes, is provided inward of the bobbin 63 of the second housing 62. With this structure, the fastening member 91 passes inside the bobbin 63. The structure in which the fastening member 91 passes inside the bobbin 63 allows an inner space of the bobbin 63 to be used effectively. A portion of the accommodation case 60 that is outward of the bobbin 63 does not need to have a space in which the fastening member 91 passes. This decreases the size of the meter stay 50.

In the example shown in FIG. 7 through FIG. 9, the bobbin 63 is hollow. The bobbin 63 is not limited to being hollow, and may have, for example, a solid column structure.

As described above, the second housing 62 includes the boss 64 for positioning. In this preferred embodiment, as shown in FIG. 8, in a planar view as seen in the axial direction of the bobbin 63, length L2 of a distance between the boss 64 and the fastening member 91 is longer than length L1 of a distance between the boss 64 and the central axis CA1 of the bobbin 63. As can be seen, the position at which the first housing 61 and the second housing 62 are secured to each other by the fastening member 91 is far from the boss 64. This reduces or prevents a deviation of the relative positions of the first housing 61 and the second housing 62.

As shown in FIG. 9, length L3 of a distance between an outer circumference of the bobbin 63 and an outer circumference of the boss 64 is longer than diameter D1 of the electric cable 105. This allows a space to accommodate the electric cable 105 to be provided between the bobbin 63 and the boss 64.

Length L3 of the distance between the outer circumference of the bobbin 63 and the outer circumference of the boss 64 may be shorter than about twice the diameter D1 of the electric cable 105. With this structure, the space accommodating the electric cable 105 is provided while the size of the accommodation case 60 in the diametric direction of the bobbin 63 is decreased. This structure also causes the electric cable 105 wound around the bobbin 63 to contact the boss 64. This reduces or prevents a deviation of the position of the electric cable 105. In the case where the electric cable 105 is to be wound around the bobbin 63 at least twice, the electric cable 105 may be wound while being shifted in the axial direction AD1 of the bobbin 63. In the case where the boss 64 includes a rib, length L3 may be the length between the rib of the boss 64 and the outer circumference of the bobbin 63.

As described above, in a preferred embodiment of the present invention, the bobbin 63 is integral and unitary with the second housing 62. This allows an inner wall of the second housing 62 to act as a flange of the bobbin 63. The integral manufacture of the second housing 62 and the bobbin 63 decreases the number of components. In the case where the second housing 62 and the bobbin 63 are made of a resin, the integral manufacture thereof is made easy.

The second housing 62 may be made of a resin whereas the first housing 61 may be made of a metal material. Manufacture of the first housing 61 of a metal material easily provides the meter stay 50 with a required level of strength. Manufacture of the second housing 62 of a resin makes the meter stay 50 lightweight. In the case where the electric cable 105 has a large load imposed thereon, the second housing 62 made of a resin may be broken and thus reduces or prevents destruction of the rest of the meter stay 50 and the meter 70.

In a preferred embodiment of the present invention, the accommodation case 60 includes the two openings 87 and 88 through which the electric cable 105 passes. With this structure, a portion of the electric cable 105 that extends from the accommodation case 60 toward the meter 70 and a portion of the electric cable 105 that extends from the accommodation case 60 toward the operation device 100 are allowed to pass through the different openings 87 and 88. If there is only one opening, the accommodation case 60 needs to have a space that guides the two portions of the electric cable 105 to the one opening, which increases the size of the accommodation case 60. In this preferred embodiment, such a space is not needed, and therefore, the size of the accommodation case 60 is decreased.

The openings 87 and 88 provided in the accommodation case 60 open in the diametric direction of the bobbin 63. If the openings 87 and 88 open in the axial direction AD1 of the bobbin 63, the accommodation case 60 needs to have a space that allows the electric cable 105 to pass through the openings 87 and 88 while the electric cable 105 is slightly bent. This increases the size of the accommodation case 60 in the axial direction AD1 of the bobbin 63. In this preferred embodiment, the structure in which the openings 87 and 88 are open in the diametric direction of the bobbin 63 decreases the size of the accommodation case 60 in the axial direction AD1 of the bobbin 63.

The openings 87 and 88 provided in the accommodation case 60 are located below a central portion of the accommodation case 60 in the up-down direction of the electrically assisted bicycle 1. The central portion of the accommodation case 60 in the up-down direction may be, for example, the position of the central axis CA1 of the bobbin 63 or a position in the vicinity thereof. With this structure, the electric cable 105 extends from a position in the accommodation case 60 that is not easily viewed from the rider. This improves the appearance of the electrically assisted bicycle 1. In addition, this structure reduces or prevents entry of water into the accommodation case 60 through the openings 87 and 88.

In a preferred embodiment of the present invention, as shown in FIG. 2, the meter 70 and the accommodation case 60 are located so as not to overlap each other in a top view of the electrically assisted bicycle 1. If the accommodation case 60 protrudes from the meter 70 as seen from the rider, the meter 70 may appear to have a large size to the rider. In this preferred embodiment, the meter 70 and the accommodation case 60 do not overlap each other as seen from the rider. Therefore, the meter 70 looks neat, and the appearance of the electrically assisted bicycle 1 is improved.

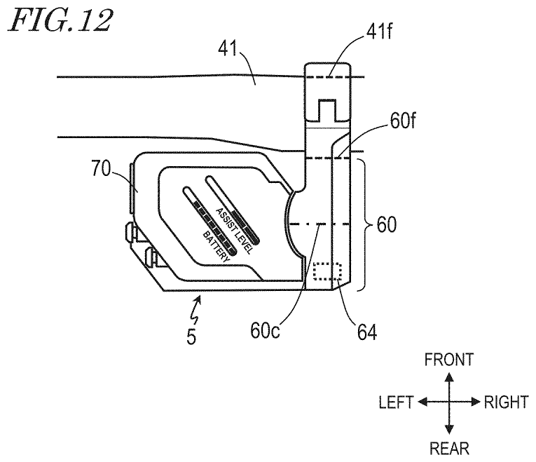

FIG. 12 is a top view of the meter unit 5 attached to the handle bar 41 of the electrically assisted bicycle 1. The accommodation case 60 of the meter unit 5 may be located to the rear of the handle bar 41. For example, a front end 60f of the accommodation case 60 may be located to the rear of a front end 41f of the handle bar 41. In this preferred embodiment, the positional arrangement in which “the front end 60f of the accommodation case 60 is located to the rear of the front end 41f of the handle bar 41” encompasses a positional arrangement in which the front end 60f and the front end 41f are at the same position in the front-rear direction. The accommodation case 60 does not protrude outward (for example, forward) from the electrically assisted bicycle 1. This structure reduces or prevents contact of the accommodation case 60 with an object located in the vicinity of the electrically assisted bicycle 1. The structure in which the accommodation case 60 does not protrude outward from the electrically assisted bicycle 1 improves the appearance of the electrically assisted bicycle 1.

The boss 64 included in the accommodation case 60 is located to the rear of a central portion 60c of the accommodation case 60 in the front-rear direction. The boss 64 is used to position the first housing 61 and the second housing 62 with respect to each other. At a position closer to the boss 64, the first housing 61, and the second housing 62 may be positionally deviated less from each other. In this preferred embodiment, the boss 64 is located at a position in the accommodation case 60 that is close to a portion viewable by the rider. This reduces or prevents the deviation of the relative positions of the first housing 61 and the second housing 62 in the portion viewable from the rider, and improves the appearance of the electrically assisted bicycle 1.

In the above description, the meter unit 5 is attached to the handle bar 41. The meter unit 5 is not limited to being attached thereto. The meter unit 5 may be attached to, for example, the handle column 13 or the handle stem 42. In such a case also, the accommodation case 60 may be located such that the axial direction AD1 of the bobbin 63 extends in the above-described direction, so that the accommodation case 60 is inconspicuous to the rider and the appearance of the electrically assisted bicycle 1 is improved.

An external device connected with the meter 70 via the electric cable 105 is not limited to the operation device 100. The external device connected with the meter 70 via the electric cable 105 may be, for example, the driving unit 30. The accommodation case 60 in this preferred embodiment accommodates the extra portion of the electric cable 105, which improves the appearance of the electrically assisted bicycle 1.

Illustrative preferred embodiments of the present invention have been described above.

The meter stay 50 according to a preferred embodiment of the present invention is structured to attach the meter 70 to a vehicle. The meter stay 50 includes the base 51 to support the meter 70 displaying information, the accommodation case 60 to accommodate a portion of the electric cable 105 to electrically connect the meter 70 and an external device to each other, the bobbin 63 around which a portion of the electric cable 105 is windable and located inside the accommodation case 60, and the attachment tool 52 to attach the base 51 and the accommodation case 60 to the vehicle. The axial direction AD1 of the bobbin 63 has a polar angle larger than about 45 degrees and smaller than about 135 degrees with respect to the normal direction ND1 to the display plane 72 of the meter 70 supported by the base 51.

In order to reduce the load imposed on the electric cable 105 caused by bending the electric cable 105, the electric cable 105 is wound around the bobbin 63 while being slightly bent. This increases the size, in the diametric direction, of the bobbin 63, around which the electric cable 105 is wound, and also increases the size of the accommodation case 60 in the diametric direction of the bobbin 63. If the axial direction AD1 of the bobbin 63 is close to the normal direction ND1 to the display plane 72 of the meter 70, the large surface of the accommodation case 60 extending in the diametric direction of the bobbin 63 is conspicuous to the rider of the vehicle. This spoils the appearance of the vehicle.

According to a preferred embodiment of the present invention, the axial direction AD1 of the bobbin 63 has a polar angle larger than about 45 degrees and smaller than about 135 degrees with respect to the normal direction ND1 to the display plane 72 of the meter 70. With this arrangement, the large surface of the accommodation case 60 extending in the diametric direction of the bobbin 63 is made inconspicuous to the rider, and the appearance of the vehicle is improved.

Even in the case where there is no component such as a brake wire or the like that is to be bundled with the electric cable 105, the extra portion of the electric cable 105 may be accommodated in the accommodation case 60 to alleviate the slack state of the electric cable 105.

In a preferred embodiment, the accommodation case 60 may include the first housing 61 and the second housing 62 assembled together to define the space therebetween to accommodate the bobbin 63 and the portion of the electric cable 105. The first housing 61 and the second housing 62 may be secured to each other by the fastening member 91. The fastening member 91 may pass inside the bobbin.

The structure in which the fastening member 91 passes inside the bobbin 63 allows the inner space of the bobbin 63 to be used effectively. A portion of the accommodation case 60 that is outward of the bobbin 63 does not need to have a space in which the fastening member 91 passes. This decreases the size of the meter stay 50.

In a preferred embodiment, the accommodation case 60 may include the first housing 61 and the second housing 62 assembled together to define the space therebetween to accommodate the bobbin 63 and the portion of the electric cable 105, and the boss 64 to position the first housing 61 and the second housing 62 with respect to each other. The first housing 61 and the second housing 62 may be secured to each other by the fastening member 91. Length L2 of the distance between the boss 64 and the fastening member 91 may be longer than length L1 of the distance between the boss 64 and the central axis CA1 of the bobbin 63 in a planar view as seen in the axial direction AD1 of the bobbin 63.

With this structure, the position at which the first housing 61 and the second housing 62 are secured to each other by the fastening member 91 is far from the boss 64. This reduces or prevents a deviation of the relative positions of the first housing 61 and the second housing 62.

In a preferred embodiment, the accommodation case 60 may include the first housing 61 and the second housing 62 assembled together to define the space therebetween to accommodate the bobbin 63 and the portion of the electric cable 105, and the boss 64 to position the first housing 61 and the second housing 62 with respect to each other. Length L3 of the distance between the outer circumference of the bobbin 63 and the outer circumference of the boss 64 may be longer than diameter D1 of the electric cable 105 and shorter than about twice the diameter D1 of the electric cable 105.

With this structure, the space accommodating the electric cable 105 is provided while the size of the accommodation case 60 in the diametric direction of the bobbin 63 is decreased. This structure also causes the electric cable 105 wound around the bobbin 63 to contact the boss 64. This reduces or prevents a deviation of the position of the electric cable 105.

In a preferred embodiment, the accommodation case 60 may include the first housing 61 and the second housing 62 assembled together to define the space therebetween to accommodate the bobbin 63 and the portion of the electric cable 105. The bobbin 63 and one of the first housing 61 and the second housing 62 may be integral and unitary with each other.

This structure allows the inner wall of the housing to act as a flange of the bobbin 63. The integral and unitary housing and the bobbin 63 decreases the number of components. In the case where the housing and the bobbin 63 are integrally made of a resin, the manufacture thereof is made easy.

In a preferred embodiment, the accommodation case 60 may include the first housing 61 and the second housing 62 assembled together to define the space therebetween to accommodate the bobbin 63 and the portion of the electric cable 105. The first housing 61 may be connected with the base 51 and the attachment tool 52. The first housing 61 may be made of a metal material. The second housing 62 may be made of a resin material.

Manufacture of the first housing 61 of a metal material provides the meter stay 50 with a required level of strength. Manufacture of the second housing 62 of a resin makes the meter stay 50 lightweight. In the case where the electric cable 105 has a large load imposed thereon, the second housing 62 made of a resin may be broken and thus reduces or prevents destruction of the rest of the meter stay 50 and the meter 70.

In a preferred embodiment, the accommodation case 60 may include the opening 87 or 88 through which the electric cable 105 passes. The opening 87 or 88 may be open in the diametric direction of the bobbin 63.

If the opening 87 or 88 is open in the axial direction AD1 of the bobbin 63, the accommodation case 60 needs to have a space that allows the electric cable 105 to pass through the opening 87 or 88 while the electric cable 105 is slightly bent. This increases the size of the accommodation case 60 in the axial direction AD1 of the bobbin 63. The structure in which the opening 87 or 88 is open in the diametric direction of the bobbin 63 decreases the size of the accommodation case 60 in the axial direction AD1 of the bobbin 63.

In a preferred embodiment, the accommodation case 60 may include a plurality of openings 87 and 88 through which the electric cable 105 passes.

With this structure, a portion of the electric cable 105 that extends from the accommodation case 60 toward the meter 70 and a portion of the electric cable 105 that extends from the accommodation case 60 toward an external device are allowed to pass through the different openings 87 and 88. This structure does not require the accommodation case 60 to have a space that guides the two portions of the electric cable 105 to one opening 87 or 88, and therefore, decreases the size of the accommodation case 60.

In a preferred embodiment, a size of the accommodation case 60 as seen in the axial direction AD1 of the bobbin 63 may be larger than a size of the meter 70 as seen in the normal direction ND1 to the display plane 72 of the meter 70.

Even in the case where the size of the accommodation case 60 is larger than the size of the meter 70, the accommodation case 60 is made inconspicuous to the rider.

The meter unit 5 according to a preferred embodiment of the present invention includes the meter stay 50 described above, and the meter 70 to display information, wherein the meter 70 is supported by the base 51.

The meter unit 5 has a good appearance with the accommodation case 60 being inconspicuous to the rider.

The bicycle 1 according to a preferred embodiment of the present invention includes the meter unit 5.

The bicycle 1 has a good appearance with the accommodation case 60 being inconspicuous to the rider.

In a preferred embodiment, the meter 70 and the accommodation case 60 may not overlap each other as seen in a top view of the bicycle 1.

If the accommodation case 60 protrudes from the meter 70 as seen from the rider, the meter 70 may appear to have a large size to the rider. In this preferred embodiment, the meter 70 and the accommodation case 60 do not overlap each other as seen from the rider. Therefore, the meter 70 looks neat, and the appearance of the electrically assisted bicycle 1 is improved.

In a preferred embodiment, the meter stay 50 may be attached to the handle bar 41, the handle stem 42, or the handle column 13. The front end 60f of the accommodation case 60 may be located to the rear of the front end 41f of the handle bar 41, the handle stem 42, or the handle column 13.

With this structure, the accommodation case 60 does not protrude outward from the electrically assisted bicycle 1. This structure reduces or prevents contact of the accommodation case 60 with an object located in the vicinity of the electrically assisted bicycle 1. The structure in which the accommodation case 60 does not protrude outward from the electrically assisted bicycle 1 improves the appearance of the electrically assisted bicycle 1.

In a preferred embodiment, the axial direction AD1 of the bobbin 63 may have a polar angle θ₁ larger than about 45 degrees and smaller than about 135 degrees with respect to the up-down direction of the bicycle 1.

Even in the case where the size of the accommodation case 60 in the diametric direction of the bobbin 63 is large, the bicycle 1 has a good appearance with the accommodation case 60 being inconspicuous to the rider.

In a preferred embodiment, the meter stay 50 may be attached to the handle bar 41, the handle stem 42, or the handle column 13. The accommodation case 60 may include the first housing 61 and the second housing 62 assembled together to define the space therebetween to accommodate the bobbin 63 and the portion of the electric cable 105, and the boss 64 to position the first housing 61 and the second housing 62 with respect to each other. The boss 64 may be located to the rear of a central portion of the accommodation case 60 in the front-rear direction of the bicycle 1.

At a position closer to the boss 64, the first housing 61 and the second housing 62 may be positionally deviated less from each other. In this preferred embodiment, the boss 64 is located at a position in the accommodation case 60 that is close to a portion viewable by the rider. This improves the appearance of the electrically assisted bicycle 1.

In a preferred embodiment, the accommodation case 60 may include the opening 87 or 88 through which the electric cable 105 passes. The opening 87 or 88 may be located below a central portion of the accommodation case 60 in the up-down direction of the bicycle 1.

With this structure, the electric cable 105 extends from a position in the accommodation case 60 that is not easily viewed from the rider. This improves the appearance of the electrically assisted bicycle 1. In addition, this structure reduces or prevents entry of water into the accommodation case 60 through the opening 87 or 88.

Preferred embodiments of the present invention are especially useful in the field of vehicles including a meter.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A meter stay to attach a meter to a vehicle, the meter stay comprising:
a base to support the meter;
an accommodation case to accommodate a portion of an electric cable to electrically connect the meter and an external device to each other;
a bobbin around which a portion of the electric cable is windable and located inside the accommodation case; and
an attachment tool to attach the base and the accommodation case to the vehicle; wherein
an axial direction of the bobbin has a polar angle larger than about 45 degrees and smaller than about 135 degrees with respect to a direction normal to a display plane of the meter supported by the base.

2. The meter stay according to claim 1, wherein
the accommodation case includes a first housing and a second housing defining a space therebetween to accommodate the bobbin and the portion of the electric cable;
the first housing and the second housing are secured to each other by a fastener; and
the fastener extends inside the bobbin.

3. The meter stay according to claim 1, wherein the accommodation case includes:
a first housing and a second housing defining a space therebetween to accommodate the bobbin and the portion of the electric cable;
a boss to position the first housing and the second housing with respect to each other;
the first housing and the second housing are secured to each other by a fastener; and
a distance between the boss and the fastener is longer than a distance between the boss and a central axis of the bobbin in a planar view as seen in the axial direction of the bobbin.

4. The meter stay according to claim 1, wherein the accommodation case includes:
a first housing and a second housing defining a space therebetween to accommodate the bobbin and the portion of the electric cable;
a boss to position the first housing and the second housing with respect to each other; and
a distance between an outer circumference of the bobbin and an outer circumference of the boss is longer than a diameter of the electric cable and shorter than about twice the diameter of the electric cable.

5. The meter stay according to claim 1, wherein the accommodation case includes:
a first housing and a second housing defining a space therebetween to accommodate the bobbin and the portion of the electric cable; and
the bobbin and one of the first housing and the second housing are integral and unitary with each other.

6. The meter stay according to claim 1, wherein the accommodation case includes:
a first housing and a second housing defining a space therebetween to accommodate the bobbin and the portion of the electric cable;
the first housing is connected with the base and the attachment tool;
the first housing is made of a metal material; and
the second housing is made of a resin material.

7. The meter stay according to claim 1, wherein
the accommodation case includes an opening through which the electric cable passes; and
the opening opens a diametric direction of the bobbin.

8. The meter stay according to claim 1, wherein the accommodation case includes a plurality of openings through which the electric cable passes.

9. The meter stay according to claim 1, wherein a size of the accommodation case as seen in the axial direction of the bobbin is larger than a size of the meter as seen in the direction normal to the display plane of the meter.

10. A meter unit comprising:
the meter stay according to claim 1; and
a meter to display information and supported by the base.

11. A bicycle comprising:
the meter unit according to claim 10.

12. The bicycle according to claim 11, wherein the meter and the accommodation case do not overlap each other as seen in a top view of the bicycle.

13. The bicycle according to claim 11, wherein
the meter stay is attached to a handle bar, a handle stem, or a handle column of the bicycle; and
a front end of the accommodation case is located rearward of a front end of the handle bar, the handle stem, or the handle column.

14. The bicycle according to claim 11, wherein the axial direction of the bobbin has a polar angle larger than about 45 degrees and smaller than about 135 degrees with respect to an up-down direction of the bicycle.

15. The bicycle according to claim 11, wherein
the meter stay is attached to a handle bar, a handle stem, or a handle column;
the accommodation case includes:
a first housing and a second housing defining a space therebetween to accommodate the bobbin and the portion of the electric cable; and
a boss to position the first housing and the second housing with respect to each other; and
the boss is located rearward of a central portion of the accommodation case in a front-rear direction of the bicycle.

16. The bicycle according to claim 11, wherein
the accommodation case includes an opening through which the electric cable passes; and
the opening is located below a central portion of the accommodation case in an up-down direction of the bicycle.
